(19) United States
(12) Patent Application Publication
(10) Pub. No.: US 2026/0166453 A1
(43) Pub. Date: Jun. 18, 2026

(54) A MULTI-PROCESS FILTERING AND DRYING APPARATUS

(71) Applicant: GMM PFAUDLER LIMITED, Karamsad, Gujarat (IN)

(72) Inventors: Manish Navaneetlal SHAH, Karamsad, Gujarat (IN); Hitesh Harshadbhai PATEL, Karamsad, Gujarat (IN)

(21) Appl. No.: 19/127,175

(22) PCT Filed: Nov. 2, 2023
(86) PCT No.: PCT/IN2023/051005

§ 371 Date: May 5, 2025

(30) Foreign Application Priority Data
Nov. 3, 2022 (IN) 202221062804

(51) Int. Cl. B01D 29/64; B01D 29/68; B01D 29/86; B01D 35/18

(52) U.S. Cl. CPC B01D 29/6476; B01D 29/68; B01D 29/86; B01D 35/18

(57) ABSTRACT

The present invention discloses a multi-process apparatus for solid-liquid filtration in pharma, chemical, pesticides, food, dyes and rubber industry. The said apparatus (100) is a shell mainly classified into head portion (6), top portion (7), bottom portion (8), bottom end portion (9), agitating means, filtration means and an actuating means, wherein said agitating means comprises a rotating agitator (10) with a hollow shaft, and plurality of hollow blades connected to a main drive shaft connection. The present invention further relates to a process of operation for using the said apparatus (100) comprising the steps of mixing, followed by filtration to separate solids from liquids, then washing to remove impurities, and finally, drying using heat and vacuum. Further, the said apparatus (100) is highly efficient for handling a wide range of solid materials, making it a versatile and essential tool in industries where these processes are required.

### FIELD OF INVENTION

The present invention relates to an apparatus for solid-liquid filtration in pharma, chemical, pesticides, food, dyes, plastic, and rubber industry. More particularly, the present invention relates to an apparatus adapted to carry multiple process steps of mixing, filtering, washing and drying in a single apparatus. The present invention further relates to a method of solid-liquid filtration using said apparatus.

### BACKGROUND OF THE INVENTION

In pharma, chemical, pesticides, food, dyes and rubber industry, the process of solid-liquid filtration involves filtering and drying in order to produce dry powder and granules.

For any chemical, pharmaceutical or biochemical processes, filtering, washing, drying as well as mixing are essential stages for the purpose of separating solid liquid suspension particles.

Conventionally, several separate equipment's are available in the market for each process of mixing, filtering, washing and drying.

U.S. Pat. No. 4,376,705A discloses a filtering and drying apparatus comprising a vertically disposed casing, a detachable bottom plate, a filter plate, a valve chamber for discharging the cakes, and an upright rotary shaft with at least a pair of rotary arms having a plurality of stirring blades to scrape off the cakes. However, U.S. '705 fails to provide a temperature controlled, jacketed, fixed or tiltable vessel with lower cycle time, improved efficiency, better CIP, and smaller footprint.

Due to the current industrial demand in equipment's with lower cycle time, improved efficiency, better CIP and smaller footprint, there is a requirement for new-generation equipment's in many segments including pharma and chemical.

Thus, there is a need of a unified multi-process apparatus with low energy consumption, minimal material contamination, simplified material replacement and electromechanical integration, higher thermal efficiency and reduced factory footprint area.

The present invention thus discloses an apparatus that complies with all the process steps of mixing, filtering, washing and drying in a single apparatus.

### SUMMARY OF THE INVENTION

It is an object of the present invention to provide a unified apparatus to facilitate multiple process steps such as mixing, filtering, washing and drying in a single apparatus.

It is yet another object of the present invention to provide a multi-process apparatus with better mixing, higher filtration area, higher heating area for drying, smaller footprint, improved cake washing, fast filtration, less heal volume and offering of standard reactor mechanical seal.

It is yet another object of the present invention to provide a closed equipment for handling hazardous materials such as flammable, explosive, toxic, or highly toxic substances and ideal for processing delicate products like chemical, food, biological products, and pharmaceuticals, to prevent contamination.

It is yet another object of the present invention to provide a conical system which allows for stirring, mixing, and agitation before filtration; and supports cleaning, regeneration, drying, and other process operations within the same unit after filtration.

It is yet another object of the present invention to enhance production efficiency, minimize material contamination, and simplify material replacement and electromechanical integration.

It is yet another object of the present invention to substantially reduce material intervention, energy consumption, overall batch cycle time and footprint.

It is yet another object of the present invention to significantly reduce the factory footprint area by 41-58%, required for the entire production process, leading to cost savings.

In an embodiment, the multi-process apparatus mainly comprises of a head portion, top portion, bottom portion, end portion, an agitating means and an actuating means.

Accordingly, the multi-process integrated filtering and drying apparatus for solid-liquid filtration comprises, an actuating means having a motor along with a gear box connected to a rotary union; a head portion attached to said actuating means with a mechanical seal, and having a feed inlet port, a wash nozzle, a sight glass, a chopper means, a dust filter with vacuum system, and an agitator means; a top portion attached below the head portion, having a first surface filtration unit with filter media on the inner surface; a bottom portion attached below the top portion, having a second surface filtration unit with filter media on the inner surface along with a draining unit coupled with vacuum system; a bottom discharge port having a third surface filtration unit with filter media and sampling discharge valve; wherein said agitating means comprises a rotating agitator with a hollow shaft, and plurality of hollow blades with variable pitch, and is connected with a main drive shaft connection; wherein said top portion and the bottom portion comprises a jacket covering with utility connections for heating or cooling.

In an embodiment, the top portion is conical or cylindrical body portion, which is adapted to provide heating as well as cooling to the mixture, with smaller footprint for the same throughput compared to conventional equipment.

In an embodiment, the bottom portion is conical in shape, which is adapted to provide heating as well as cooling to the mixture.

In an embodiment, the rotating agitator comprises of a hollow shaft, and plurality of hollow blades with variable pitch.

In an embodiment, the top portion, bottom portion and bottom end portion further comprises a filtration unit with filter media selected from a filter cloth or a multi-layered sintered filtration media.

The present invention further relates to a process of operation of said apparatus.

### BRIEF DESCRIPTION OF DRAWINGS

The figures below show an exemplary embodiment:

FIGS. 1A, 1B & 1C illustrates a schematic view of the apparatus.

FIG. 2A, 2B illustrates a head portion of the said apparatus

FIG. 2C illustrates an adjustable heat able vortex breaker/baffle

FIGS. 3A, 3B & 3C illustrates a top portion, bottom portion, and bottom cover end of the said apparatus

FIG. 4 illustrates the different types of external jacket in top and bottom portion of the vessel.

FIG. 5 illustrates a tilting mechanism.

FIG. 6 illustrates different spiral blade profiles of agitator shaft.

FIG. 7 illustrates a spiral blade of agitator shaft with different cross-section profile

FIG. 8 illustrates an agitator shaft with brazing arm comprising different cross section.

FIG. 9 illustrates an agitator shaft with spiral blade comprising the pitch blade or plough shape blade at the shaft end

FIG. 10 illustrates an agitator shaft with sleeve and a support bush at bottom cover end

FIG. 11 illustrates a secondary rotary union

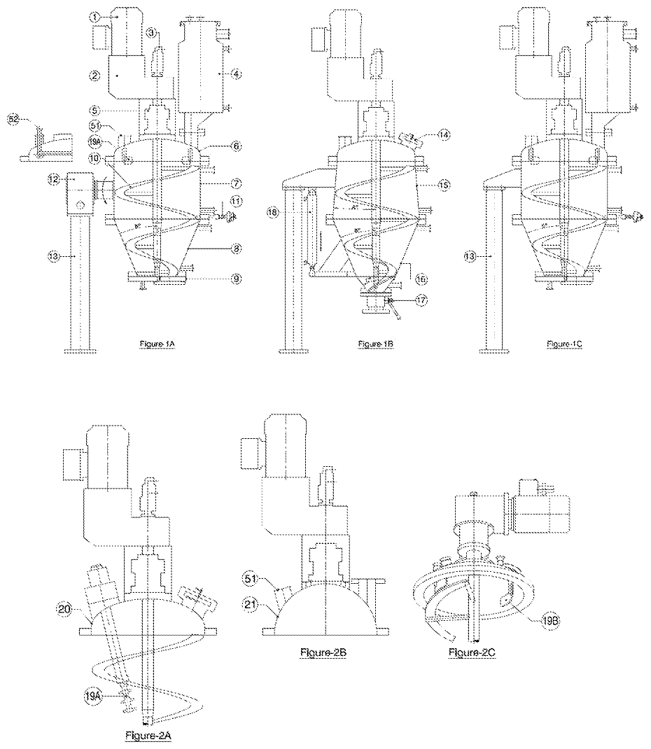

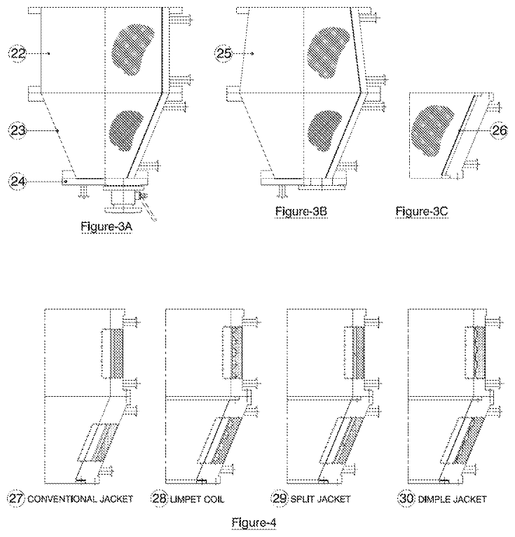

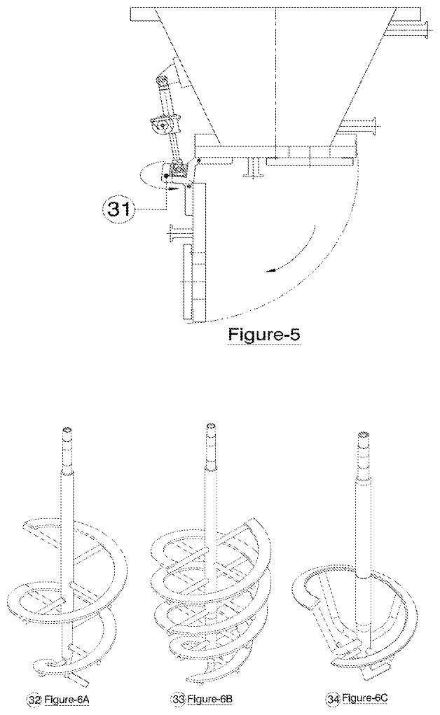

The following table describes reference numeral and the associated part description.

| Part ref | Part Description | FIG. |
|---|---|---|
| 100 | Multi-process integrated filtering and drying | |
| | apparatus | |
| 1 | Motor | FIG. 1A |
| 2 | Gear box | |
| 3 | Primary rotary union | |
| 4 | Dust filter | |
| 5 | Mechanical seal | |
| 6 | Head portion (Torispherical head) | |
| 7 | Top portion - Cylindrical (jacketed) | |
| 8 | Bottom portion - cone (jacketed) | |
| 9 | Bottom end cover (jacketed) | |
| 10 | Agitator shaft with spiral blade | |
| 11 | Resistance temperature detector (RTD) sensor | |
| 12 | Gear for tiltable vessel | |
| 13 | Leg or side bracket support | |
| 14 | Sight glass & Light glass | FIG. 1B |
| 15 | Top portion - cone (jacketed) | |
| 16 | Bottom portion - double cone (jacketed) | |
| 17 | Outlet valve | |
| 18 | Mechanical actuator (Hydraulic cylinder for | |
| | bottom cone up-down) | |
| 19A, | Vortex or foam breaker (top entry) | FIG. 1A |
| 19B | | & 2C |
| 20 | Head portion (Ellipsoidal dish-end) | FIG. 2A |
| 21 | Head portion (Spherical dish-end) | FIG. 2B |
| 22 | Top portion with media or clothes -cylindrical | FIG. 3A |
| | shell | |
| 23 | Bottom portion with media or clothes - cone | |
| 24 | Bottom end cover with media or clothes | |
| 25 | Top portion with media or clothes- cone | FIG. 3B |
| 26 | Bottom portion with detachable filter media | FIG. 3C |
| 27 | Conventional Jacket | FIG.-4 |
| 28 | Limpet Coil | |
| 29 | Split Jacket | |
| 30 | Dimple Jacket | |
| 31 | Tilting mechanism for CIP-SIP | FIG.-5 |
| 32 | Single helix agitator | FIG.-6A |
| 33 | Double helix agitator | FIG.-6B |
| 34 | Single helix agitator suitable for top entry | FIG.-6C |
| | vortex or foam breaker | |
| 35 | Hollow aerophoil shape | FIG.-7A |
| 36 | Hollow elliptical shape | |
| 37 | Hollow rectangular shape | |
| 38 | Hollow rectangular with reference cone angle | |
| 39 | Hollow blade with reference cone angle | |
| 40 | Hollow ratchet profile | FIG.-7B |
| 41 | Hollow curved tooth profile | |
| 42 | Hollow std. profile | |
| 43 | Hollow circular support arm | FIG.-8 |
| 44 | Hollow elliptical support arm | |
| 45 | Hollow prism support arm | |
| 46 | Sampling valve | FIG.-9A |
| 47 | Shaft with steady bearing | FIG.-9B |
| 48 | Pitch blade + scrapper | FIG.-10 |
| 49 | Vertical scrapper | FIG.-10 |
| 50 | Secondary rotary union | FIG.-11 |
| 51 | Feed inlet nozzle | FIG.-1&2 |
| 52 | Wash nozzle | FIG.-1&2 |

### DESCRIPTION OF THE INVENTION

The invention is described herein in detail with the help of figures appended at the end of the specification. The figures illustrate the preferred embodiment as well as other embodiments that define the scope of the present invention. However, it may be understood that the figures presented herein are intended to exemplify the scope of the invention only. The person skilled in art may note that by no means the figures limit the scope of the invention. Any variation in the drawings by any other person will be falling in the scope of the present invention.

As illustrated in FIGS. 1-11, a conical or biconical shaped fixed or tiltable vessel apparatus with multiple process steps such as mixing, filtration, washing and drying is disclosed.

Referring to FIGS. 1A, 1B and 1C, a schematic view of the multi-process integrated fixed or tiltable filtering and drying apparatus (100) is disclosed. The said apparatus (100) is a vessel mainly classified into head portion, top portion, bottom portion, end portion, rotating agitator (agitating means) and an actuating means.

According to FIGS. 1A and 1C, the said actuating means further comprises a motor (1) along with a gear box (2) is connected to a rotary union (3) for actuating the apparatus (100). A mechanical seal (5) is connected to said rotary union (5) and an agitator shaft with spiral blade (10) is placed within the vessel. The vessel mainly comprises a head portion (6), a jacketed top portion (7), a jacketed bottom portion (8) and a jacketed bottom end cover portion (9). The said head portion (6) further comprises a feed inlet port (51), a wash nozzle (52), a sight glass (14), a dust filter (4) with a vacuum system, and a chopper means (19) comprising a vortex or foam breaker (19A,19B) and a motor is placed within said head portion (6). The said apparatus (100) further comprises an agitating means having a rotating agitator (10) with a hollow shaft, and plurality of hollow blades with variable pitch, and is connected to a main drive shaft connection. Further, a resistance temperature detector (RTD) sensor (11) is assembled at the top portion (7) to measure the temperature of product within the apparatus at all locations. The said apparatus (100) is fixed or tiltable and is supported by a tilting means with gear (12) and is held upright by a side bracket support (13).

According to FIG. 1B, a schematic view of biconical shaped vessel is disclosed. The FIG. 1B discloses a sight glass and light glass (14), jacketed cone top (15), jacketed double cone bottom (16), a mechanical actuator (18) to enable opening and movement of bottom portion (8) along the vertical axis, and an outlet valve (17).

Referring to FIGS. 2A and 2B illustrates the head portion of said apparatus. The FIG. 2A discloses an ellipsoidal head portion (20) with a vortex or foam breaker/baffles (19A,19B); whereas FIG. 2B discloses and a feed inlet nozzle (51) on a spherical head portion (21). Further, FIG. 2C illustrates an adjustable vortex or foam breaker/baffles (19A, 19B).

Referring to FIGS. 3A, 3B and 3C illustrates the placement of filter media on a top portion, bottom portion and end portion respectively of said apparatus (100). FIG. 3A illustrates a cylindrical top portion with filter media (22), a conical bottom portion with filter media (23), and an end portion with filter media (24). Similarly, FIG. 3B illustrates a conical top portion and conical bottom portion with filter media (25). Further, FIG. 3C illustrates a conical bottom portion with detachable filter media (26).

Referring to FIG. 4 illustrates the different types of external jacket in top and bottom portion of the vessel for maintaining temperature in a vessel such as, a conventional jacket (27) welded on the top and bottom portion for controlling temperature; a limpet coil (28) welded on the top and bottom portion for maintaining temperature in the vessel; a split jacket (29) and a dimple jacket (30) for specific temperature controlling.

Referring to FIG. 5 illustrates the tilting mechanism (31) assembled at the bottom portion of the vessel for CIP (clean-in-place) and SIP (sterilization-in-place). The said mechanism enables tilting of vessel during cleaning or sterilization processes.

Referring to FIGS. 6A, 6B and 6C, illustrates different spiral blade profiles of agitator shaft assembled with gearbox and rotary union for mixing. FIG. 6A, discloses a single helix agitator (32) blade for mixing. FIG. 6B discloses a double helix agitator (33) having two helical blades for enhanced mixing. FIG. 6C discloses a single helix agitator (34) with a helical blade, for use with a top-entry vortex or foam breaker.

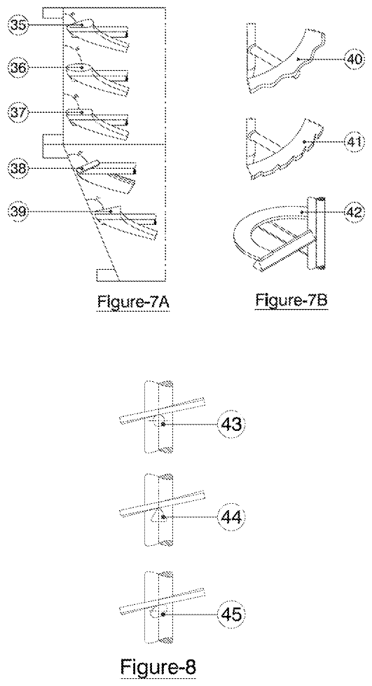

Referring to FIGS. 7A and 7B, illustrates plurality of spiral blades welded with agitator shaft through brazing arms, each having different shapes and cross-section profiles respectively, such as hollow aerophoil shape (35), hollow elliptical shape (36), hollow rectangular shape (37), hollow rectangular with reference cone angle (38) and hollow blade with reference cone angle (39); and hollow ratchet profile (40), hollow curved tooth profile (41) and hollow standard profile (42).

Referring to FIG. 8, illustrates plurality of agitator shaft with brazing arm comprising different types of cross sections, such as hollow circular support arm (43), hollow elliptical support arm (44) and hollow prism support arm (45).

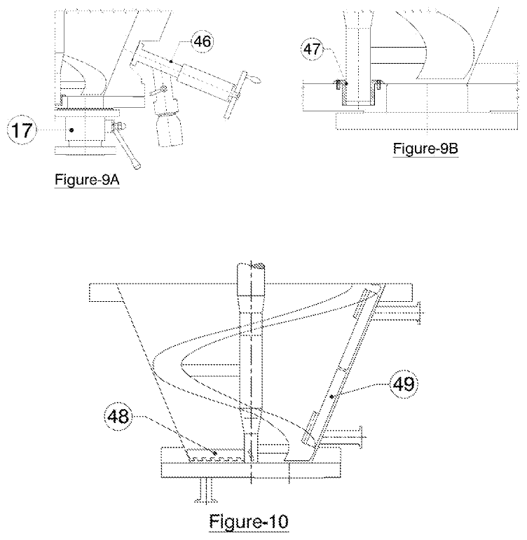

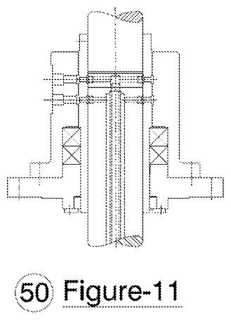

Referring to FIG. 9A illustrates position of sampling valve (46) assembled with bottom portion for collecting product samples. Referring to FIG. 9B illustrates position of a steady bush bearing (47) assembled at shaft end with bottom end cover. The said bush at bottom end cover acts as a steady bearing for stability, to reduce the shaft deflection and to lower the critical speed of agitator shaft.

Referring to FIG. 10 illustrates an agitator shaft (10) having a pitch blade cum scrapper (48) assembled with the shaft at bottom end for efficient mixing and scrapping; a vertical scrapper (49) assembled with the shaft at bottom end to remove material from the inner walls of the vessel in a vertical direction for CIP purpose.

Referring to FIG. 11 illustrates a secondary rotary union (50) which is a pre-assembled device, mounted on main agitator shaft, comprising a rotary union integrated with mechanical sealing along with ports for heating and cooling utility. The mechanical seal integrated with a rotary union prevents leakage in rotating equipment while allowing fluid transfer.

In a preferred embodiment according to the present invention, a multi-process integrated filtering and drying apparatus (100) for solid-liquid filtration comprises, an actuating means having a motor (1) along with a gear box (2) connected to a primary rotary union (3); a head portion (6) attached to said actuating means with a mechanical seal (5), and having a feed inlet port (51), a wash nozzle (52), a sight glass (14), a chopper means (19), a dust filter (4) with a vacuum system and an agitator means; a top portion (7) attached below the head portion, having a first surface filtration unit with filter media (22,25) on the inner surface; a bottom portion (8) attached below the top portion, having a second surface filtration unit with filter media (23,26) on the inner surface; a bottom end portion (9) attached below the bottom portion, having an outlet discharge valve (17), a third surface filtration unit with filter media (24) and a sampling discharge valve (46); and a supporting means having a support bracket (13) assembled with the vessel and fixed on ground, a mechanical actuator (18) assembled with bottom portion of the vessel and said support bracket (13) to enable opening and movement of bottom portion (8) along the vertical axis; wherein said agitating means comprises a rotating agitator (10) with a hollow shaft, and plurality of hollow blades with variable pitch, and is connected to a main drive shaft connection; wherein said top portion, bottom portion and bottom end portion are covered with a temperature control jacket having utility connections for heating or cooling.

In a same preferred embodiment according to the present invention, said filtering and drying apparatus (100) is rigidly fixed, or tiltable.

In a same preferred embodiment according to the present invention, said filtering and drying apparatus (100) comprises a tilting mechanism having a gear for tiltable vessel (12) assembled with a side bracket support (13) and the vessel for tilting.

In a same preferred embodiment according to the present invention, said apparatus (100) is selected from a biconical or conical shaped vessel having different cone angle at upper side and bottom side.

In a same preferred embodiment according to the present invention, said agitator (10) is a heatable agitator to control the temperature of the mixture.

In a same preferred embodiment according to the present invention, said agitator (10) is selected from helix agitator.

In a same preferred embodiment according to the present invention, said agitator shaft (10) comprises a spiral blade with a pitch blade or plough shape blade at the shaft end to work as scrapper.

In a same preferred embodiment according to the present invention, said agitator shaft (10) comprises spiral blade profiles selected from single helix, double helix, helix with different pitch/angle and cross-section profiles.

In a same preferred embodiment according to the present invention, said agitator shaft (10) comprises a brazing arm with different cross section selected from hollow circular support arm, hollow elliptical support arm and hollow prism support arm.

In a same preferred embodiment according to the present invention, said spiral blade cross section profiles may be selected from hollow rectangular, hollow elliptical, hollow aerophoil, hollow ratchet, hollow standard and hollow curved tooth profile.

In a same preferred embodiment according to the present invention, said agitator shaft (10) comprises a bush at bottom portion end to act as a steady bearing and to reduce the shaft deflection and to lower the critical speed of agitator.

In a same preferred embodiment according to the present invention, said apparatus (100) comprises a temperature sensor means having plurality of sensors mounted on said agitator shaft (10) to measure the temperature of the material.

In a same preferred embodiment according to the present invention, said plurality of sensors mounted on said agitator shaft (10) measures the temperature of the material and communicates to a transmitter.

In a same preferred embodiment according to the present invention, said transmitter and plurality of sensors are connected through a wire routed through said agitator shaft (10) and rotary union (3).

In a same preferred embodiment according to the present invention, connection between said transmitter and plurality of sensors is selected from a wired, wireless connection.

In a same preferred embodiment according to the present invention, said dust filter (4) comprises a filter media to retain the lighter micro powder particle moving outside with solvent vapour under vacuum.

In a same preferred embodiment according to the present invention, said chopper means (19) comprises a motor and a vortex or foam breaker (19A,19B) mounted to the head portion of the vessel to improve the mixing and reduce the granular sizes.

In a same preferred embodiment according to the present invention, said filtration unit with filter media (22,23,24,25,26) is selected from a filter cloth or a multi-layered sintered filtration media.

In a same preferred embodiment according to the present invention, said filter cloth is a wedge wire screen made of alloy steel.

In a same preferred embodiment according to the present invention, said multi-layered sintered filtration media or wire cloth is selected from Perfluoroalkoxy (PFA), Polypropylene (PP), Polytetrafluoroethylene (PTFE).

In a same preferred embodiment according to the present invention, said filtration unit with filter media (22,23,24,25,26) is selected from rigidly fixed, bolted or detachable filtration unit.

In a same preferred embodiment according to the present invention, said apparatus (100) comprises a secondary rotary union (50) for sealing agitator shaft, heating and cooling connection, and absorbing heavy-duty radial and axial loads coming from helix agitator.

In a same preferred embodiment according to the present invention, said primary rotary union (3) comprises a sensor to measure temperature and vibration on agitator (10).

In a same preferred embodiment according to the present invention, said apparatus (100) comprises a resistance temperature detector (RTD) sensor (11) mounted on side wall of flange at junction between top portion and bottom portion, to measure material temperature.

In a same preferred embodiment according to the present invention, said jacket is selected from conventional jacket, limpet coil, dimple jacket and split jacket.

In a same preferred embodiment according to the present invention, a process of operating a multi-process integrated filtering and drying apparatus (100) comprises the steps of,
Step A, comprise of mixing process, wherein solid materials are mixed and homogenized using an agitator (10);
Step B, comprise of filtration process, wherein the homogenized mixture is filtered through a first filter media (22,25);
Step C, comprise of washing process, wherein the filtered mixture is washed to remove impurities and again filtered through a second filter media (23,26);
Step D, comprise of drying process, wherein the washed and filtered mixture is dried by heating the mixture using the heatable agitator (10) and by applying vacuum pressure.

In a same preferred embodiment according to the present invention, said mixing process comprises the steps of, feeding solid materials in the vessel through feed inlet nozzle (51); mixing and homogenizing solid materials in the vessel using a heatable agitator (10);

In a same preferred embodiment according to the present invention, said filtration process comprises the steps of, draining out the liquid through the outlet valve (17) from the homogenized mixture through the filter media (22,23,24,25,26), while retaining the solids on the filter surface; creating a pressure differential using a vacuum system of the dust filter (4) to draw the liquid and leaving the solids behind.

In a same preferred embodiment according to the present invention, said washing process comprises the steps of, adding washing liquid into the apparatus (100) through the wash nozzle (52) to remove impurities and unwanted solvents from the filtered solid material; mixing the filtered solid material and the washing liquid thoroughly by the agitator (10); creating a pressure differential using a vacuum system of the dust filter (4) to draw the liquid through the filter media (22,23,24,25,26), leaving the solids behind.

In a same preferred embodiment according to the present invention, said drying process comprises the steps of, drying the remaining washed and filtered solid material; heating said material using the agitator (10) to facilitate the drying process; applying vacuum pressure using dust filter (4) to lower the pressure inside the apparatus (100) and to prevent thermal degradation.

In a same preferred embodiment according to the present invention, said heatable agitator (10) is heated to control the temperature of the mixture.

In a same preferred embodiment according to the present invention, wherein the mixing and movement of materials forms a thin layered cake, to provide high filtering and washing efficiency during filtering process.

In an exemplary embodiment, the head portion of the said apparatus (100) may be flat, spherical, torispherical, ellipsoidal.

In an embodiment, the top portion is conical or cylindrical body portion, which is adapted to provide heat to the mixture.

In an embodiment, the bottom portion is conical in shape, which is adapted to provide heating as well as cooling to the mixture.

The said end portion comprises a discharge valve for CIP-SIP application, wherein said discharge valve is connected through a fixed or tilting mechanism.

In a more preferred embodiment according to the present invention, a hollow shaft with a hollow spiral blade acts as a rotating agitator in the apparatus. The said hollow spiral blade comprises variable pitch which lifts the material and pushes the material out when it is discharged.

In a same preferred embodiment according to the present invention, said spiral blade agitator uniformly agitates the materials in all process steps thus, increasing the working efficiency of the whole apparatus. Further, the spiral blade with scrapper mechanism also lowers the heal volume in apparatus and improves the CIP.

Furthermore, mixing and movement of materials according to the said apparatus (100) forms a thin layered cake, thus providing high filtering and washing efficiency during filtering process.

The said secondary rotary union (50) also isolates heat transfer from wet shaft to drive shaft.

The heating and cooling connections are set on the top portion and the bottom portion to heat or cool the material.

Further, said filtration unit with a mechanical structure is arranged on the top and bottom portion of the apparatus.

The said bottom portion is arranged for quick opening to discharge the material from the apparatus.

Furthermore, the cylinder jackets, cone jackets, hollow shafts and hollow spiral blades with different profiles according to the present invention, heat or cool materials simultaneously, with low energy consumption and higher thermal efficiency.

Furthermore, higher filtration and heating area in the said apparatus (100) results in smaller footprint compared to conventional apparatus, for the same throughput.

In a same preferred embodiment according to the present invention, the helix blade will be right angle to cone and shell surface.

In a same preferred embodiment according to the present invention, the cone angle at the top portion angle (A) ranges between 5 degree to 20 degree; bottom portion angle (B) ranges between 15 degree to 50 degree and bottom end portion angle (C) ranges between 15 degree to 60 degree.

In an exemplary embodiment according to the present invention, the dynamic heat transfer area is 2.2 to 3.4 times more compared to conventional equipment.

In an exemplary embodiment according to the present invention, the heal volume is 22 to 38% less compared to conventional equipment.

In an exemplary embodiment according to the present invention, the reduction in batch time for filtration and drying ranges between 30 to 40%.

In an exemplary embodiment according to the present invention, the filtration and heat transfer area increased to 1.2 to 1.8 times.

In an exemplary embodiment according to the present invention, the reduction in footprint ranges from 41% to 58% due to lesser equipment diameter.

The advantages of the present invention include a multi-process apparatus with lower cycle time, improved efficiency, better CIP, and smaller footprint, low energy consumption, minimal material contamination, simplified material replacement and electromechanical integration, higher thermal efficiency and reduced factory area. Further, the present invention minimizes product and operator exposure thus yielding in lowest product contamination.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A multi-process integrated filtering and drying apparatus (100) for solid-liquid filtration comprising,
an actuating means having a motor (1) along with a gear box (2) connected to a primary rotary union (3);
a head portion (6) attached to said actuating means with a mechanical seal (5), and having a feed inlet port (51), a wash nozzle (52), a sight glass (14), a chopper means (19), a dust filter (4) with a vacuum system and an agitator means;
a top portion (7) attached below the head portion, having a first surface filtration unit with filter media (22,25) on the inner surface;
a bottom portion (8) attached below the top portion, having a second surface filtration unit with filter media (23,26) on the inner surface;
a bottom end portion (9) attached below the bottom portion, having an outlet discharge valve (17), a third surface filtration unit with filter media (24) and a sampling discharge valve (46); and
a supporting means having a support bracket (13) assembled with the vessel and fixed on ground, a mechanical actuator (18) assembled with bottom portion (8) of the vessel and said support bracket (13) to enable opening and movement of bottom portion (8) along the vertical axis;
wherein said agitating means comprises a rotating agitator (10) with a hollow shaft, and plurality of hollow blades with variable pitch, and is connected to a main drive shaft connection;
wherein said top portion, bottom portion and bottom end portion are covered with a temperature control jacket having utility connections for heating or cooling.

2. The apparatus (100) as claimed in claim 1, wherein said filtering and drying apparatus (100) is rigidly fixed, or tiltable, and is a bioconal or conical shaped vessel having a different cone angle at an upper side and a bottom side.

3. The apparatus (100) as claimed in claim 1, wherein said filtering and drying apparatus (100) comprises a tilting mechanism having a gear for tiltable vessel (12) assembled with a side bracket support (13) and the vessel for tilting.

4. (canceled)

5. The apparatus (100) as claimed in claim 1, wherein said agitator (10) is a heatable agitator to control the temperature of the mixture, and is selected from a helix agitator.

6. (canceled)

7. The apparatus (100) as claimed in claim 1, wherein said agitator shaft (10) comprises a spiral blade with a pitch blade or plough shape blade at the shaft end to work as scrapper.

8. The apparatus (100) as claimed in claim 1, wherein said agitator shaft (10) comprises spiral blade profiles selected from single helix, double helix, helix with different pitch/angle and cross-section profiles.

9. The apparatus (100) as claimed in claim 1, wherein said agitator shaft (10) comprises a brazing arm with different cross section selected from hollow circular support arm, hollow elliptical support arm and hollow prism support arm.

10. The apparatus (100) as claimed in claim 5, wherein said spiral blade cross section profiles may be selected from hollow rectangular, hollow elliptical, hollow aerophoil, hollow ratchet, hollow standard and hollow curved tooth profile.

11. The apparatus (100) as claimed in claim 1, wherein said agitator shaft (10) comprises a bush at bottom portion end to act as a steady bearing and to reduce the shaft deflection and to lower the critical speed of agitator.

12. The apparatus (100) as claimed in claim 1, wherein said apparatus (100) comprises a temperature sensor means having a plurality of sensors mounted on said agitator shaft (10) to measure the temperature of the material.

13. The apparatus (100) as claimed in claim 1, wherein said dust filter (4) comprises a filter media to retain the lighter micro powder particle moving outside with solvent vapour under vacuum.

14. The apparatus (100) as claimed in claim 1, wherein said chopper means (19) comprises a motor and a vortex or foam breaker (19A,19B) mounted to the head portion of the vessel to improve the mixing and reduce the granular sizes.

15. The apparatus (100) as claimed in claim 1, wherein said filtration unit with filter media (22,23,24,25,26) is selected from a filter cloth, such as a wedge or wire screen made of alloy steel or a multi-layered sintered filtration media, such as selected from Perfluoroalkoxy (PF A), Polypropylene (PP), Polytetrafluoroethylene (PTFE).

16. (canceled)

17. (canceled)

18. The apparatus (100) as claimed in claim 1, wherein said filtration unit with filter media (22,23,24,25,26) is selected from rigidly fixed, bolted or detachable filtration unit.

19. The apparatus (100) as claimed in claim 1, wherein said apparatus (100) comprises a secondary rotary union (50) for sealing agitator shaft, heating and cooling connection, and absorbing heavy-duty radial and axial loads coming from helix agitator.

20. The apparatus (100) as claimed in claim 1, wherein said primary rotary union (3) comprises a sensor to measure temperature and vibration on agitator (10).

21. The apparatus (100) as claimed in claim 1, wherein said apparatus (100) comprises a resistance temperature detector (RTD) sensor (11) mounted on side wall of flange at junction between top portion and bottom portion, to measure material temperature.

22. The apparatus (100) as claimed in claim 1, wherein said jacket is selected from conventional jacket, limpet coil, dimple jacket and split jacket.

23. The apparatus (100) as claimed in claim 1, wherein the cone angle at the top portion angle (A) ranges between 5 degree to 20 degree; bottom portion angle (B) ranges between 15 degree to 50 degree and bottom end portion angle (C) ranges between 15 degree to 60 degree.

24. A process of operating a multi-process integrated filtering and drying apparatus (100) comprises the steps of,
Step A, comprise of mixing process, wherein solid materials are mixed and homogenized using an agitator (10);
Step B, comprise of filtration process, wherein the homogenized mixture is filtered through a first filter media (22,25);
Step C, comprise of washing process, wherein the filtered mixture is washed to remove impurities and again filtered through a second filter media (23,26);
Step D, comprise of drying process, wherein the washed and filtered mixture is dried by heating the mixture using the heatable agitator (10) and by applying vacuum pressure.

25. The process as claimed in claim 24, wherein said mixing process comprises the steps of,
feeding solid materials in the vessel through feed inlet nozzle (51);
mixing and homogenizing solid materials in the vessel using a heatable agitator (10), which forms a thin layered cake, to provide high filtering and washing efficiency during filtering process.

26. The process as claimed in claim 24, wherein said filtration process comprises the steps of,
draining out the liquid through the outlet valve (17) from the homogenized mixture through the filter media (22,23,24,25,26), while retaining the solids on the filter surface;
creating a pressure differential using a vacuum system of the dust filter (4) to draw the liquid and leaving the solids behind.

27. The process as claimed in claim 24, wherein said washing process comprises the steps of,
adding washing liquid into the apparatus (100) through the wash nozzle (52) to remove impurities and unwanted solvents from the filtered solid material;
mixing the filtered solid material and the washing liquid thoroughly by the agitator (10);
creating a pressure differential using a vacuum system of the dust filter (4) to draw the liquid through the filter media (22,23,24,25,26), leaving the solids behind.

28. The process as claimed in claim 24, wherein said drying process comprises the steps of,
drying the remaining washed and filtered solid material;
heating said material using the agitator (10) to facilitate the drying process;
applying vacuum pressure using dust filter (4) to lower the pressure inside the apparatus (100) and to prevent thermal degradation.

29. (canceled)

30. (canceled)
